(19) United States
(12) Patent Application Publication
(10) Pub. No.: US 2007/0164250 A1
(43) Pub. Date: Jul. 19, 2007

(54) Nanoparticle heating and applications thereof

(76) Inventors: Kimberly Hamad-Schifferli, Somerville, MA (US); Andy Wijaya, Cambridge, MA (US)

Correspondence Address: PEARL COHEN ZEDEK LATZER, LLP, 1500 BROADWAY 12TH FLOOR, NEW YORK, NY, 10036, US

(21) Appl. No.: 11/588,417

(22) Filed: Oct. 27, 2006

Related U.S. Application Data
(60) Provisional application No. 60/730,384, filed on Oct. 27, 2005.

(51) Int. Cl. H01F 1/00; C04B 35/00; H01F 1/04; C01G 49/08; C04B 35/26; C04B 35/40

(52) U.S. Cl. 252/62.51 C; 252/62.56; 252/62.51 R; 252/62.55; 252/62.57; 252/62.58; 252/62.59; 252/62.6; 252/62.61; 252/62.62; 252/62.63; 252/62.64; 252/62.52

(57) ABSTRACT

This invention provides magnetic nanoparticles, which when placed in a magnetic field are selectively heated at a certain frequency of the magnetic field, as a function of their size, composition, or both. The invention also provides for use of such nanoparticles, in applications including, inter alia, selective nanoparticle heating and applications thereof, hyperthermia induction in cells or tissue, remote alteration of protein structure and/or drug delivery.

### CROSS-REFERENCE TO RELATED APPLICATIONS

This Application claims the benefit of U.S. Provisional Application Ser. No. 60/730,384, filed Oct. 27, 2005, which is hereby incorporated by reference in its entirety.

### FIELD OF THE INVENTION

This invention is directed to, inter alia, magnetic nanoparticles, which when placed in a magnetic field are selectively heated at a certain frequency of the magnetic field, as a function of their size, composition, or both, and applications thereof, including, inter alia, hyperthermia induction in cells or tissue, remote alteration of protein structure and/or drug delivery.

### BACKGROUND OF THE INVENTION

Biological systems far exceed any man-made machine in terms of efficiency, precision, and complexity, yet control and fine-tuning of such systems remains somewhat out of reach. Ideally, the ability to develop antennas to control individual biological molecules externally and to use these antennas to directly manipulate complex biological systems, would find a multitude of applications, from drug delivery, targeted disease therapy, such as cancer, time and spatially-controlled biological cascades, to name but a few critical systems, which would be positively affected by such a control mechanism.

### SUMMARY OF THE INVENTION

In one embodiment, this invention provides a method of selective heating of at least one magnetic nanoparticle in a composition comprising a plurality of magnetic nanoparticles, said method comprising the step of exposing said composition to a magnetic field, whereby said at least one nanoparticle dissipates greater heat upon exposure to said magnetic field, at a defined frequency, than another nanoparticle in said plurality.

In another embodiment, this invention provides a method for inducing hyperthermia in a cell or tissue comprising the steps of:
i. contacting said cell or tissue with a plurality of magnetic nanoparticles, wherein at least one nanoparticle in said plurality dissipates greater heat upon exposure to a magnetic field, at a defined frequency, than another nanoparticle in said plurality; and
ii. exposing said cell or tissue to a magnetic field, at said defined frequency.

In another embodiment, this invention provides a method for remotely altering the structure of at least one protein in a plurality of proteins, the method comprising the steps of:
a. linking magnetic nanoparticles with said proteins, wherein at least one nanoparticle in said plurality dissipates greater heat upon exposure to a magnetic field, at a defined frequency, than another nanoparticle in said plurality; and
b. exposing said plurality of proteins to a magnetic field, at said defined frequency
   whereby said exposing results in an altering of the structure of said protein.

In another embodiment, this invention provides a method of drug delivery in a subject, comprising the steps of:
a. encapsulating a drug in structures comprising magnetic nanoparticles, wherein at least one nanoparticle in said nanoparticles dissipates greater heat upon exposure to a magnetic field, at a defined frequency, than another nanoparticle;
b. exposing said structures to a magnetic field, at said defined frequency; and
c. administering said structures to a subject;
   whereby said exposing results in an altering of said structures such that said drug is released in said subject.

In another embodiment, this invention provides a composition or kit comprising a plurality of magnetic nanoparticles for administration to a human subject, wherein at least one nanoparticle in said plurality dissipates greater heat upon exposure to a magnetic field, at a defined frequency, than another nanoparticle in said plurality.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 plots the calculated frequency dependence for Fe₃O₄.

FIG. 2 plots the calculated field amplitude dependence for CoFe₂O₄.

FIG. 3A plots the calculated power dissipated by nanoparticles, comprised of different materials.

FIG. 3B plots the power dissipated by nanoparticles, with varied size. FIG. 3C shows SEM micrographs of the nanoparticles.

FIG. 3D plots the power dissipated by nanoparticles, comprised of different materials and different size. Blue: 10 nm CoFe₂O₄, Black: 9 nm Fe₃O₄, red: 4 nm Fe₂O₃. The power is varied over three different frequency ranges.

FIG. 4A demonstrates an embodiment of a biological application of the methods of the invention, which attach the nanoparticles to biomolecules, which may change from active to inactive states, as a function of heat applied.

FIG. 4B demonstrates an embodiment of a biological application of the methods of the invention, showing the possibility of multichannel addressing by varying the size/composition of the nanoparticles. Power absorbance is plotted as a function of frequency (left panel).

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

One of the principles of the methods of this invention is the heating of magnetic nanoparticles, when placed in a magnetic field. Depending on the particle size, particle composition, or combination thereof, particles are selectively heated at a certain frequency of the magnetic field, as a function of their size, composition, or both.

Magnetic nanoparticles can be heated by alternating magnetic fields. This heating behavior is governed by the power loss equation (EQ. 1), which shows that heating at a given frequency and field strength depends on nanoparticle size and material.

$$P = \frac{{( m H ω {τ}_{eff} )}^{2}}{2 {k}_{B} {τ}_{eff} TV ( 1 + {ω}^{2} {τ}_{eff}^{2} )} \qquad ( EQ 1 )$$

where m is the magnetic moment, V the nanoparticle volume, H the field strength and ω the field frequency.

τ_{eff} is the relaxation time, which is provided by the following equation (EQ. 2):

$${τ}_{eff} = \frac{{τ}_{N} {τ}_{B}}{{τ}_{N} + {τ}_{B}} \qquad ( EQ . 2 )$$

τ_{B} is the Brownian (rotational) relaxation loss timescale, which is provided by the following equation (EQ. 3):

$${τ}_{B} = \frac{8 π η {R}_{H}^{3}}{{k}_{B} T} \qquad ( EQ . 3 )$$

τ_{N} is the timescale for Néel relaxation power losses, which is provided by the following equation (EQ. 4):

$${τ}_{N} = {τ}_{0} exp \frac{KV}{{k}_{B} T} \qquad ( EQ . 4 )$$

where η is the solvent viscosity and R_{H} the hydrodynamic radius of the nanoparticle and where K is the anisotropy constant of the material.

The power equation shows that heating of a nanoparticle of a particular size (V, R_{H}) and material (m, K) varies with field frequency (ω) and field strength (H). This equation shows that heating is non-resonant, as a broad range of frequencies can heat the nanoparticles.

In one embodiment, the size of the nanoparticles for use in the present invention may be adjusted or optimized and reflect the choice of the nanoparticle material and the frequency and/or strength of the magnetic field. In another embodiment, the size of the nanoparticles for use in the present invention is 4-25 nm, in another embodiment, 8-15 nm, in another embodiment, 1-100 nm, in another embodiment, 1-800 nm, in another embodiment, 1-50 nm, in another embodiment, 50-200 nm, in another embodiment, 200-500 nm, in another embodiment, 500-800 nm, in another embodiment, 200-600 nm, in another embodiment, 2-10 nm, in another embodiment, 5-25 nm, or in another embodiment, 25-75 nm.

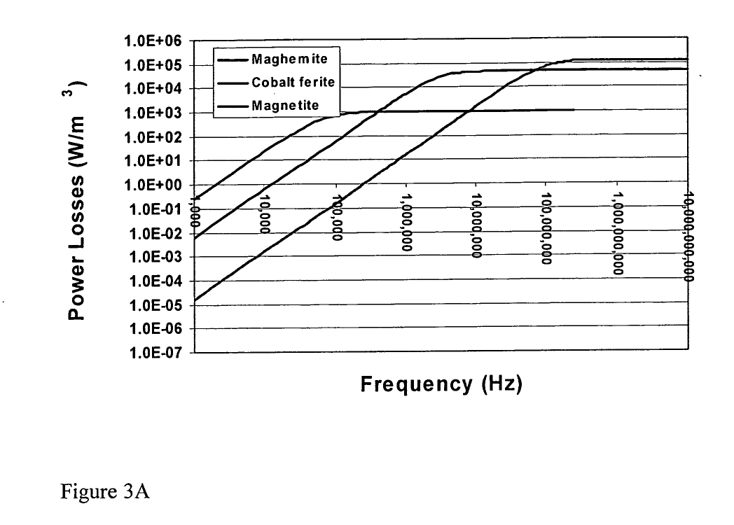

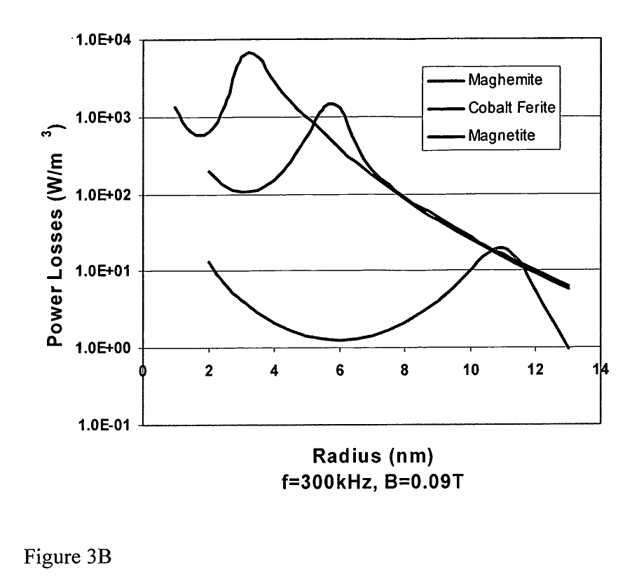

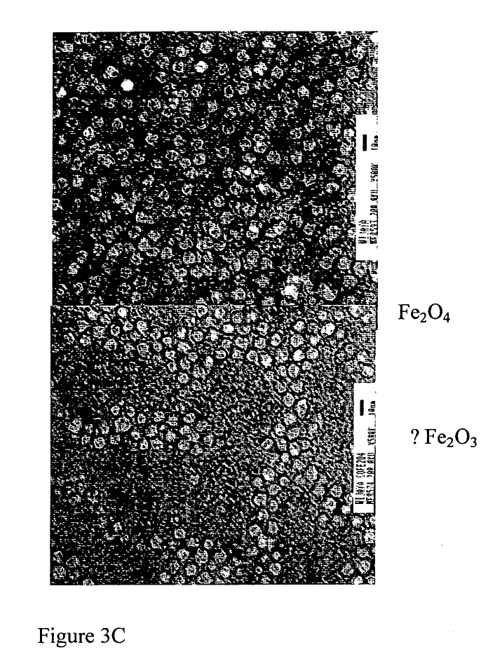

A method for independently heating different nanoparticle types that can be applied for situations in which heating behavior is non-resonant, can thus be obtained. Based on the above, the choice of nanoparticle material and/or size, heating of one type and not the other can be achieved at a given frequency, as is demonstrated in Example 2 (FIG. 3A).

Magnetic materials (such as the Ferro V magnetic pigment) transduce energy when exposed to a magnetic field of sufficient intensity; for example, an alternating magnetic field will induce an alternating current in the particle, producing heat. According to the invention, other metal or magnetic materials, such as Fe₃O₄, Fe₂O₃, silver, copper, platinum, palladium may comprise the nanoparticles of this invention. In another embodiment, said nanoparticles may be from TiO₂, CeO₂, Silver, CuO, yttrium aluminum garnet (YAG), InO₂, CdS, ZrO₂, or a combination thereof. In another embodiment, any metal oxide, metal alloy, metal carbide, transit metal, may be used in the instant invention. In some embodiments, the particles may be coated, such that the coating does not alter their respective responsiveness to the applied field. In another embodiment, nanoparticles of the present invention may be made of magnetic materials, while in another embodiment, they may be made or paramagnetic or superparamagnetic materials.

Mechanisms of controlling biology are not limited to induction heating but also include magnetic hysteresis heating and photochemical induced activity. In one embodiment, the present invention makes use of these phenomena for the development of antennas for controlling biological systems, using in some embodiments, both inorganic materials and chemical moieties. In some embodiments, the invention exploits size- and material-dependent properties of nanocrystals to achieve a means of independent control of multiple biomolecules, as described and claimed herein.

In one embodiment, this invention provides a composition or kit comprising a plurality of magnetic nanoparticles, wherein at least one nanoparticle of said plurality dissipates greater heat upon exposure to a magnetic field, at a defined frequency, than another nanoparticle in said plurality.

In one embodiment, the plurality comprises magnetic nanoparticles which differ in terms of their composition, radius, or combination thereof. In one embodiment, the nanoparticles comprise CoFe₂O₄, Fe₃O₄, Fe₂O₃, or a combination thereof, or any suitable magnetic material which may be used to prepare nanoparticles for use according to the methods of this invention.

In one embodiment, this invention provides a method of selective heating of at least one magnetic nanoparticle in a composition comprising a plurality of magnetic nanoparticles, said method comprising the step of exposing said composition to a magnetic field, whereby said at least one nanoparticle dissipates greater heat upon exposure to said magnetic field, at a defined frequency, than another nanoparticle in said plurality.

In another embodiment, this invention provides a method for inducing hyperthermia in a cell or tissue comprising the steps of:
i. contacting said cell or tissue with a plurality of magnetic nanoparticles, wherein at least one nanoparticle in said plurality dissipates greater heat upon exposure to a magnetic field, at a defined frequency, than another nanoparticle in said plurality; and
ii. exposing said cell or tissue to a magnetic field, at said defined frequency.

In one embodiment, the nanoparticles comprise CoFe₂O₄, Fe₃O₄, Fe₂O₃, or a combination thereof. In one embodiment, the magnetic nanoparticles differ in terms of their composition, radius, or combination thereof, and/or in another embodiment, comprise at least one targeting moiety, which in another embodiment, is a receptor, a cross-linking agent, a nucleic acid, an antibody or antibody fragment, a peptide, an oligonucleotide, a drug, a ligand for a biological target, an immunoconjugate, a chemomimetic functional group, a glycolipid, a labeling agent, an enzyme, a metal ion chelate, an enzyme cofactor, a cytotoxic compound, a growth factor, a hormone, a cytokine, a toxin, a prodrug, an antimetabolite, a microtubule inhibitor, a radioactive material, or combination thereof.

In one embodiment, the term “antibody or antibody fragment” refers to intact antibody molecules as well as functional fragments thereof, such as Fab, F(ab′)2, and Fv that are capable of binding to an epitope. In one embodiment, an Fab fragment refers to the fragment which contains a monovalent antigen-binding fragment of an antibody molecule, which can be produced by digestion of whole antibody with the enzyme papain to yield an intact light chain and a portion of one heavy chain. In one embodiment, Fab′ fragment refers to a part of an antibody molecule that can be obtained by treating whole antibody with pepsin, followed by reduction, to yield an intact light chain and a portion of the heavy chain. Two Fab′ fragments may be obtained per antibody molecule. In one embodiment, (Fab′)₂ refers to a fragment of an antibody that can be obtained by treating whole antibody with the enzyme pepsin without subsequent reduction. In another embodiment, F(ab′)₂ is a dimer of two Fab′ fragments held together by two disulfide bonds. In one embodiment, Fv, may refer to a genetically engineered fragment containing the variable region of the light chain and the variable region of the heavy chain expressed as two chains. In one embodiment, the antibody fragment may be a single chain antibody (“SCA”), a genetically engineered molecule containing the variable region of the light chain and the variable region of the heavy chain, linked by a suitable polypeptide linker as a genetically fused single chain molecule.

Methods of making these fragments are known in the art. (See for example, Harlow and Lane, Antibodies: A Laboratory Manual, Cold Spring Harbor Laboratory, New York, 1988, incorporated herein by reference).

In one embodiment, the antibody will recognize an epitope, which in another embodiment, refers to antigenic determinant on an antigen to which the paratope of an antibody binds. Epitopic determinants may, in other embodiments, consist of chemically active surface groupings of molecules such as amino acids or carbohydrate side chains and in other embodiments, may have specific three dimensional structural characteristics, and/or in other embodiments, have specific charge characteristics.

Antibody fragments according to the present invention can be prepared by proteolytic hydrolysis of the antibody or by expression in E. coli or mammalian cells (e.g. Chinese hamster ovary cell culture or other protein expression systems) of DNA encoding the fragment.

In other embodiments, antibody fragments can be obtained by pepsin or papain digestion of whole antibodies by conventional methods. For example, antibody fragments can be produced by enzymatic cleavage of antibodies with pepsin to provide a 5S fragment denoted F(ab)2. This fragment can be further cleaved using a thiol reducing agent, and optionally a blocking group for the sulfhydryl groups resulting from cleavage of disulfide linkages, to produce 3.5S Fab′ monovalent fragments. Alternatively, an enzymatic cleavage using pepsin produces two monovalent Fab′ fragments and an Fc fragment directly. These methods are described, for example, by Goldenberg, U.S. Pat. Nos. 4,036,945 and 4,331,647, and references contained therein, which patents are hereby incorporated by reference in their entirety. See also Porter, R. R., Biochem. J., 73: 119-126, 1959. Other methods of cleaving antibodies, such as separation of heavy chains to form monovalent light-heavy chain fragments, further cleavage of fragments, or other enzymatic, chemical, or genetic techniques may also be used, so long as the fragments bind to the antigen that is recognized by the intact antibody.

Fv fragments comprise an association of VH and VL chains. This association may be noncovalent, as described in Inbar et al., Proc. Nat'l Acad. Sci. USA 69:2659-62, 1972. Alternatively, the variable chains can be linked by an intermolecular disulfide bond or cross-linked by chemicals such as glutaraldehyde. Preferably, the Fv fragments comprise VH and VL chains connected by a peptide linker. These single-chain antigen binding proteins (sFv) are prepared by constructing a structural gene comprising DNA sequences encoding the VH and VL domains connected by an oligonucleotide. The structural gene is inserted into an expression vector, which is subsequently introduced into a host cell such as E. coli. The recombinant host cells synthesize a single polypeptide chain with a linker peptide bridging the two V domains. Methods for producing sFvs are described, for example, by Whitlow and Filpula, Methods, 2: 97-105, 1991; Bird et al., Science 242:423-426, 1988; Pack et al., Bio/Technology 11:1271-77, 1993; and Ladner et al., U.S. Pat. No. 4,946,778, which is hereby incorporated by reference in its entirety.

Another form of an antibody fragment is a peptide coding for a single complementarity-determining region (CDR). CDR peptides (“minimal recognition units”) can be obtained by constructing genes encoding the CDR of an antibody of interest. Such genes are prepared, for example, by using the polymerase chain reaction to synthesize the variable region from RNA of antibody-producing cells. See, for example, Larrick and Fry, Methods, 2: 106-10, 1991.

In one embodiment, the nanoparticles comprise a peptide. In one embodiment, the term “peptide” refers to native peptides (either degradation products, synthetically synthesized peptides or recombinant peptides) and/or peptidomimetics (typically, synthetically synthesized peptides), such as peptoids and semipeptoids which are peptide analogs, which may have, for example, modifications rendering the peptides more stable while in a body or more capable of penetrating into cells. Such modifications include, but are not limited to N terminus modification, C terminus modification, peptide bond modification, including, but not limited to, CH₂—NH, CH₂—S, CH₂—S═O, O═C—NH, CH₂—O, CH₂—CH₂, S═C—NH, CH═CH or CF═CH, backbone modifications, and residue modification. Methods for preparing peptidomimetic compounds are well known in the art and are specified, for example, in Quantitative Drug Design, C. A. Ramsden Gd., Chapter 17.2, F. Choplin Pergamon Press (1992), which is incorporated by reference as if fully set forth herein. Further details in this respect are provided hereinunder.

Peptide bonds (—CO—NH—) within the peptide may be substituted, for example, by N-methylated bonds (—N(CH₃)—CO—), ester bonds (—C(R)H—C—O—O—C(R)—N—), ketomethylene bonds (—CO—CH₂—), *-aza bonds (—NH—N(R)—O—), wherein R is any alkyl, e.g., methyl, carba bonds (—CH₂—NH—), hydroxyethylene bonds (—CH(OH)—CH₂—), thioamide bonds (—CS—NH—), olefinic double bonds (—CH═CH—), retro amide bonds (—NH—CO—), peptide derivatives (—N(R)—CH₂—CO—), wherein R is the “normal” side chain, naturally presented on the carbon atom.

These modifications can occur at any of the bonds along the peptide chain and even at several (2-3) at the same time. Natural aromatic amino acids, Trp, Tyr and Phe, may be substituted for synthetic non-natural acid such as TIC, naphthylelanine (Nol), ring-methylated derivatives of Phe, halogenated derivatives of Phe or o-methyl-Tyr.

In addition to the above, the peptides of the present invention may also include one or more modified amino acids or one or more non-amino acid monomers (e.g. fatty acids, complex carbohydrates etc).

In one embodiment, the term “amino acid” or “amino acids” is understood to include the 20 naturally occurring amino acids; those amino acids often modified post-translationally in vivo, including, for example, hydroxyproline, phosphoserine and phosphothreonine; and other unusual amino acids including, but not limited to, 2-aminoadipic acid, hydroxylysine, isodesmosine, nor-valine, nor-leucine and ornithine. Furthermore, the term “amino acid” may include both D- and L-amino acids.

Peptides or proteins of this invention may be prepared by various techniques known in the art, including phage display libraries [Hoogenboom and Winter, J. Mol. Biol. 227:381 (1991); Marks et al., J. Mol. Biol. 222:581 (1991)].

In one embodiment, the term “oligonucleotide” is interchangeable with the term “nucleic acid”, and may refer to a molecule, which may include, but is not limited to, prokaryotic sequences, eukaryotic mRNA, cDNA from eukaryotic mRNA, genomic DNA sequences from eukaryotic (e.g., mammalian) DNA, and even synthetic DNA sequences. The term also refers to sequences that include any of the known base analogs of DNA and RNA.

As will be appreciated by one skilled in the art, a fragment or derivative of a nucleic acid sequence or gene that encodes for a protein or peptide can still function in the same manner as the entire, wild type gene or sequence. Likewise, forms of nucleic acid sequences can have variations as compared to wild type sequences, nevertheless encoding the protein or peptide of interest, or fragments thereof, retaining wild type function exhibiting the same biological effect, despite these variations. Each of these represents a separate embodiment of this present invention.

The nucleic acids can be produced by any synthetic or recombinant process such as is well known in the art. Nucleic acids can further be modified to alter biophysical or biological properties by means of techniques known in the art. For example, the nucleic acid can be modified to increase its stability against nucleases (e.g., “end-capping”), or to modify its lipophilicity, solubility, or binding affinity to complementary sequences.

DNA according to the invention can also be chemically synthesized by methods known in the art. For example, the DNA can be synthesized chemically from the four nucleotides in whole or in part by methods known in the art. Such methods include those described in Caruthers (1985). DNA can also be synthesized by preparing overlapping double-stranded oligonucleotides, filling in the gaps, and ligating the ends together (see, generally, Sambrook et al. (1989) and Glover et al. (1995)). DNA expressing functional homologues of the protein can be prepared from wild-type DNA by site-directed mutagenesis (see, for example, Zoller et al. (1982); Zoller (1983); and Zoller (1984); McPherson (1991)). The DNA obtained can be amplified by methods known in the art. One suitable method is the polymerase chain reaction (PCR) method described in Saiki et al. (1988), Mullis et al., U.S. Pat. No. 4,683,195, and Sambrook et al. (1 989).

Methods for modifying nucleic acids to achieve specific purposes are disclosed in the art, for example, in Sambrook et al. (1989). Moreover, the nucleic acid sequences for use as a targeting moiety of the invention may include one or more portions of nucleotide sequence that are non-coding for a protein of interest. Variations in the DNA sequences, which are caused by point mutations or by induced modifications (including insertion, deletion, and substitution) to enhance the activity, half-life or production of the polypeptides encoded thereby, are also encompassed in the invention.

The nucleic acid may, in one embodiment, be DNA, or in another embodiment, the nucleic acid is RNA. In other embodiments, the nucleic acid may be single or double stranded.

In one embodiment, the activity or function of a particular gene is suppressed or diminished, via the use of antisense oligonucleotides, which are chimeric molecules, containing two or more chemically distinct regions, each made up of at least one nucleotide. In one embodiment, the antisense molecules may be conjugated to the nanoparticles of this invention.

Antisense oligonucleotides, in one embodiment, may be chimeric oligonucleotides, which contain at least one region wherein the oligonucleotide is modified so as to confer upon the oligonucleotide an increased resistance to nuclease degradation, increased cellular uptake, and/or increased binding affinity for the target polynucleotide. An additional region of the oligonucleotide may serve as a substrate for enzymes capable of cleaving RNA:DNA or RNA:RNA hybrids, which according to this aspect of the invention, serves as a means of gene silencing via degradation of specific sequences. Cleavage of the RNA target can be routinely detected by gel electrophoresis and, if necessary, associated nucleic acid hybridization techniques known in the art.

The chimeric antisense oligonucleotides may, in one embodiment, be formed as composite structures of two or more oligonucleotides and/or modified oligonucleotides, as is well described in the art (see, for example, U.S. Pat. Nos. 5,013,830; 5,149,797; 5,220,007; 5,256,775; 5,366,878; 5,403,711; 5,491,133; 5,565,350; 5,623,065; 5,652,355; 5,652,356; and 5,700,922), and can, in another embodiment, comprise a ribozyme sequence.

In another embodiment, magnetic nanoparticles may be used to control the inhibition of gene expression, activity or function via small interfering RNAs, which provides sequence-specific inhibition of gene expression. Administration of double stranded/duplex RNA (dsRNA) corresponding to a single gene in an organism can silence expression of the specific gene by rapid degradation of the mRNA in affected cells. This process is referred to as gene silencing, with the dsRNA functioning as a specific RNA inhibitor (RNAi). RNAi may be derived from natural sources, such as in endogenous virus and transposon activity, or it can be artificially introduced into cells (Elbashir S M, et al (2001). Nature 411:494-498) via microinjection (Fire et al. (1998) Nature 391: 806-11), or by transformation with gene constructs generating complementary RNAs or fold-back RNA, or by other vectors (Waterhouse, P. M., et al. (1998). Proc. Natl. Acad. Sci. USA 95, 13959-13964 and Wang, Z., et al. (2000). J. Biol. Chem. 275, 40174-40179). The RNAi mediating mRNA degradation, in one embodiment, comprises duplex or double-stranded RNA, or, in other embodiments, include single-stranded RNA, isolated RNA (partially purified RNA, essentially pure RNA, synthetic RNA, recombinantly produced RNA), as well as altered RNA that differs from naturally occurring RNA by the addition, deletion and/or alteration of one or more nucleotides.

When referring to nucleic acid sequences utilized as modulators in this invention, it is to be understood that such reference allows for the incorporation of non-nucleotide material, which may be added, for example, to the end(s) of the nucleotide sequence, including for example, terminal 3′ hydroxyl groups, or internal additions, at one or more nucleotides. Nucleic acids may, in another embodiment, incorporate non-standard nucleotides, including non-naturally-occurring nucleotides. Alterations may also include the construction of blunt and/or overhanging ends. Collectively all such altered nucleic acids may be referred to as analogs, and represent contemplated embodiments of the invention.

In another embodiment, magnetic nanoparticles may comprise oligonucleotides used to “knock out” a particular gene. Typically gene knockouts are accomplished by disrupting a gene, a promoter regulating a gene, or sequences between a promoter and a gene. Such disruption can be specifically directed to a particular gene by homologous recombination where a “knockout construct” contains flanking sequences complementary to the domain to which the construct is targeted. Insertion of the knockout construct (e.g. into the gene of interest) results in disruption of that gene. The phrases “disruption of the gene” and “gene disruption” refer to insertion of a nucleic acid sequence into one region of the native DNA sequence (in some embodiments, in one or more exons) and/or the promoter region of a gene so as to decrease or prevent expression of that gene in the cell as compared to the wild-type or naturally occurring sequence of the gene.

Knockout constructs can be produced by standard methods known to those of skill in the art. The knockout construct can be chemically synthesized or assembled, e.g., using recombinant DNA methods. The DNA sequence to be used in producing the knockout construct is digested with a particular restriction enzyme selected to cut at a location(s) such that a new DNA sequence encoding a marker gene can be inserted in the proper position within this DNA sequence. The proper position for marker gene insertion is that which will serve to prevent expression of the native gene; this position will depend on various factors such as the restriction sites in the sequence to be cut, and whether an exon sequence or a promoter sequence, or both is (are) to be interrupted (i.e., the precise location of insertion necessary to inhibit promoter function or to inhibit synthesis of the native exon).

Thus, in one embodiment, nanoparticles may be linked to a molecule and used to control the function of the molecule.

In one embodiment, the nanoparticles of this invention are targeted to cells. In one embodiment, the cell may be any responsive cell, such as, in one embodiment, an epithelial cell, a lung cell, a kidney cell, a liver cell, a cardiocyte, an astrocyte, a glial cell, a prostate cell, a professional antigen presenting cell, a lymphocyte, an M cell, a pancreatic cell, a stem cell, a myoblast, a hepatocyte, an osteoblast, an osteocyte, an osteoclast, a chondrocyte, a chodroblast, or other bone or cartilage cells and may be used for applications as described in, for example, Wilson, J. M et al. (1988) Proc. Natl. Acad. Sci. USA 85:3014-3018; Armentano, D. et al. (1990) Proc. Natl. Acad. Sci. USA 87:6141-6145; Wolff, J. A. et al. (1990) Science 247:1465-1468; Chowdhury, J. R. et al. (1991) Science 254:1802-1805; Ferry, N. et al. (1991) Proc. Natl. Acad. Sci. USA 88:8377-8381; Wilson, J. M. et al. (1992) J. Biol. Chem. 267:963-967; Quantin, B. et al. (1992) Proc. Natl. Acad. Sci. USA 89:2581-2584; Dai, Y. et al. (1992) Proc. Natl. Acad. Sci. USA 89:10892-10895; van Beusechem, V. W. et al. (1992) Proc. Natl. Acad Sci. USA 89:7640-7644; Rosenfeld, M. A. et al. (1992) Cell 68:143-155; Kay, M. A. et al. (1992) Human Gene Therapy 3:641-647; Cristiano, R. J. et al. (1993) Proc. Natl. Acad Sci. USA 90:2122-2126; Hwu, P. et al. (1993) J. Immunol. 150:4104-4115; and Herz, J. and Gerard, R. D. (1993) Proc. Natl. Acad Sci. USA 90:2812-2816.

In one embodiment, a magnetic nanoparticle may comprise or be linked to a drug. In one embodiment, the term “drug” refers to a substance applicable for use in the diagnosis, or in another embodiment, cure, or in another embodiment, mitigation, or in another embodiment, treatment, or in another embodiment, prevention of a disease, disorder, condition or infection. In one embodiment, the term “drug” refers to any substance which affect the structure or function of the target to which it is applied.

In another embodiment, the term “drug” refers to a molecule that alleviates a symptom of a disease or disorder when administered to a subject afflicted thereof. In one embodiment, a drug is a synthetic molecule, or in another embodiment, a drug is a naturally occurring compound isolated from a source found in nature.

In one embodiment, drugs may comprise antihypertensives, antidepressants, antianxiety agents, anticlotting agents, anticonvulsants, blood glucose-lowering agents, decongestants, antihistamines, antitussives, anti-inflammatories, antipsychotic agents, cognitive enhancers, cholesterol-reducing agents, antiobesity agents, autoimmune disorder agents, anti-impotence agents, antibacterial and antifungal agents, hypnotic agents, anti-Parkinsonism in agents, antibiotics, antiviral agents, anti-neoplastics, barbituates, sedatives, nutritional agents, beta blockers, emetics, anti-emetics, diuretics, anticoagulants, cardiotonics, androgens, corticoids, anabolic agents, growth hormone secretagogues, anti-infective agents, coronary vasodilators, carbonic anhydrase inhibitors, antiprotozoals, gastrointestinal agents, serotonin antagonists, anesthetics, hypoglycemic agents, dopaminergic agents, anti-Alzheimer's Disease agents, anti-ulcer agents, platelet inhibitors and glycogen phosphorylase inhibitors.

In one embodiment, examples of the drugs conjugated to the magnetic nanoparticles of this invention, comprise, inter-alia, antihypertensives including prazosin, nifedipine, trimazosin, amlodipine, and doxazosin mesylate; the antianxiety agent hydroxyzine; a blood glucose lowering agent such as glipizide; an anti-impotence agent such as sildenafil citrate; anti-neoplastics such as chlorambucil, lomustine or echinomycin; anti-inflammatory agents such as betamethasone, prednisolone, piroxicam, aspirin, flurbiprofen and (+)-N-{4-[3-(4-fluorophenoxy)phenoxy]-2-cyclopenten-1-yl}-N-hyroxyurea; antivirals such as acyclovir, nelfinavir, or virazole; vitamins/nutritional agents such as retinol and vitamin E; emetics such as apomorphine; diuretics such as chlorthalidone and spironolactone; an anticoagulant such as dicumarol; cardiotonics such as digoxin and digitoxin; androgens such as 17-methyltestosterone and testosterone; a mineral corticoid such as desoxycorticosterone; a steroidal hypnotic/anesthetic such as alfaxalone; an anabolic agent such as fluoxymesterone or methanstenolone; antidepression agents such as fluoxetine, pyroxidine, venlafaxine, sertraline, paroxetine, sulpiride, [3,6-dimethyl-2-(2,4,6-trimethyl-phenoxy)-pyridin-4-y]-(lethylpropyl)-amine or 3,5-dimethyl-4-(3′-pentoxy)-2-(2′,4′,6′-trimethylphenoxy)pyridine; an antibiotic such as ampicillin and penicillin G; an anti-infective such as benzalkonium chloride or chlorhexidine; a coronary vasodilator such as nitroglycerin or mioflazine; a hypnotic such as etomidate; a carbonic anhydrase inhibitor such as acetazolamide or chlorzolamide; an antifungal such as econazole, terconazole, fluconazole, voriconazole or griseofulvin; an antiprotozoal such as metronidazole; an imidazole-type anti-neoplastic such as tubulazole; an anthelmintic agent such as thiabendazole or oxfendazole; an antihistamine such as astemizole, levocabastine, cetirizine, or cinnarizine; a decongestant such as pseudoephedrine; antipsychotics such as fluspirilene, penfluridole, risperidone or ziprasidone; a gastrointestinal agent such as loperamide or cisapride; a serotonin antagonist such as ketanserin or mianserin; an anesthetic such as lidocaine; a hypoglycemic agent such as acetohexamide; an anti-emetic such as dimenhydrinate; an antibacterial such as cotrimoxazole; a dopaminergic agent such as L-DOPA; anti-Alzheimer agents such as THA or donepezil; an anti-ulcer agent/H2 antagonist such as famotidine; a sedative/hypnotic such as chlordiazepoxide or triazolam; a vasodilator such as alprostadil; a platelet inhibitor such as prostacyclin; an ACE inhibitor/antihypertensive such as enalaprilic acid or lisinopril; a tetracycline antibiotic such as oxytetracycline or minocycline; a macrolide antibiotic such as azithromycin, clarithromycin, erythromycin or spiramycin; and glycogen phosphorylase inhibitors such as [R-(R*S*)]5-chloro-N-[2-hydroxy-3{methoxymethylamino}-3-oxo-1-(phenylmethyl)-propyl]-1H-indole-2-carboxamide or 5-chloro-1-Hindole-2-carboxylic acid [(IS)-benzyl(2R)-hydroxy-3-((3R,4S)dihydroxy-pyrrolidin-1-yl-)-oxypropyl] amide.

Further examples of drugs deliverable by the invention are the glucose-lowering drug chlorpropamide, the anti-fungal fluconazole, the anti-hypercholesterolemic atorvastatin calcium, the antipsychotic thiothixene hydrochloride, the anxiolytics hydroxyzine hydrochloride or doxepin hydrochloride, the anti-hypertensive amlodipine besylate, the antiinflammatories piroxicam and celicoxib and valdicoxib, and the antibiotics carbenicillin indanyl sodium, bacampicillin hydrochloride, troleandomycin, and doxycycline hyclate.

In another embodiment, a drug of this invention may comprise other antineoplastic agents such as platinum compounds (e.g., spiroplatin, cisplatin, and carboplatin), methotrexate, fluorouracil, adriamycin, mitomycin, ansamitocin, bleomycin, cytosine arabinoside, arabinosyl adenine, mercaptopolylysine, vincristine, busulfan, chlorambucil, melphalan (e.g., PAM, L-PAM or phenylalanine mustard), mercaptopurine, mitotane, procarbazine hydrochloride dactinomycin (actinomycin D), daunorubicin hydrochloride, doxorubicin hydrochloride, paclitaxel and other taxenes, rapamycin, manumycin A, TNP-470, plicamycin (mithramycin), aminoglutethimide, estramustine phosphate sodium, flutamide, leuprolide acetate, megestrol acetate, tamoxifen citrate, testolactone, trilostane, amsacrine (m-AMSA), asparaginase (L-asparaginase) Erwina asparaginase, interferon .alpha.-2a, interferon .alpha.-2b, teniposide (VM-26), vinblastine sulfate (VLB), vincristine sulfate, bleomycin sulfate, hydroxyurea, procarbazine, and dacarbazine; mitotic inhibitors such as etoposide, colchicine, and the vinca alkaloids, radiopharmaceuticals such as radioactive iodine and phosphorus products; hormones such as progestins, estrogens and antiestrogens; anti-helmintics, antimalarials, and antituberculosis drugs; biologicals such as immune serums, antitoxins and antivenoms; rabies prophylaxis products; bacterial vaccines; viral vaccines; respiratory products such as xanthine derivatives theophylline and aminophylline; thyroid agents such as iodine products and anti-thyroid agents; cardiovascular products including chelating agents and mercurial diuretics and cardiac glycosides; glucagon; blood products such as parenteral iron, hemin, hematoporphyrins and their derivatives; biological response modifiers such as muramyldipeptide, muramyltripeptide, microbial cell wall components, lymphokines (e.g., bacterial endotoxin such as lipopolysaccharide, macrophage activation factor), sub-units of bacteria (such as Mycobacteria, Corynebacteria), the synthetic dipeptide N-acetyl-muramyl-L-alanyl-D-isoglutamine; anti-fungal agents such as ketoconazole, nystatin, griseofulvin, flucytosine (5-fc), miconazole, amphotericin B, ricin, cyclosporins, and β-lactam antibiotics (e.g., sulfazecin); hormones such as growth hormone, melanocyte stimulating hormone, estradiol, beclomethasone dipropionate, betamethasone, betamethasone acetate and betamethasone sodium phosphate, vetamethasone disodium phosphate, vetamethasone sodium phosphate, cortisone acetate, dexamethasone, dexamethasone acetate, dexamethasone sodium phosphate, flunisolide, hydrocortisone, hydrocortisone acetate, hydrocortisone cypionate, hydrocortisone sodium phosphate, hydrocortisone sodium succinate, methylprednisolone, methylprednisolone acetate, methylprednisolone sodium succinate, paramethasone acetate, prednisolone, prednisolone acetate, prednisolone sodium phosphate, prednisolone tebutate, prednisone, triamcinolone, triamcinolone acetonide, triamcinolone diacetate, triamcinolone hexacetonide, fludrocortisone acetate, oxytocin, vassopressin, and their derivatives; vitamins such as cyanocobalamin neinoic acid, retinoids and derivatives such as retinol palmitate, and .alpha.-tocopherol; peptides, such as manganese super oxide dismutase; enzymes such as alkaline phosphatase; anti-allergic agents such as amelexanox; anti-coagulation agents such as phenprocoumon and heparin; circulatory drugs such as propranolol; metabolic potentiators such as glutathione; antituberculars such as para-aminosalicylic acid, isoniazid, capreomycin sulfate cycloserine, ethambutol hydrochloride ethionamide, pyrazinamide, rifampin, and streptomycin sulfate; antivirals such as amantadine azidothymidine (AZT, DDI, Foscarnet, or Zidovudine), ribavirin and vidarabine monohydrate (adenine arabinoside, ara-A); antianginals such as diltiazem, nifedipine, verapamil, erythritol tetranitrate, isosorbide dinitrate, nitroglycerin (glyceryl trinitrate) and pentaerythritol tetranitrate; anticoagulants such as phenprocoumon, heparin; antibiotics such as dapsone, chloramphenicol, neomycin, cefaclor, cefadroxil, cephalexin, cephradine erythromycin, clindamycin, lincomycin, amoxicillin, ampicillin, bacampicillin, carbenicillin, dicloxacillin, cyclacillin, picloxacillin, hetacillin, methicillin, nafcillin, oxacillin, penicillin including penicillin G and penicillin V, ticarcillin rifampin and tetracycline; antiinflammatories such as diflunisal, ibuprofen, indomethacin, meclofenamate, mefenamic acid, naproxen, oxyphenbutazone, phenylbutazone, piroxicam, sulindac, tolmetin, aspirin and salicylates; antiprotozoans such as chloroquine, hydroxychloroquine, metronidazole, quinine and meglumine antimonate; antirheumatics such as penicillamine; narcotics such as paregoric; opiates such as codeine, heroin, methadone, morphine and opium; cardiac glycosides such as deslanoside, digitoxin, digoxin, digitalin and digitalis; neuromuscular blockers such as atracurium mesylate, gallamine triethiodide, hexafluorenium bromide, metocurine iodide, pancuronium bromide, succinylcholine chloride (suxamethonium chloride), tubocurarine chloride and vecuronium bromide; sedatives (hypnotics) such as amobarbital, amobarbital sodium, aprobarbital, butabarbital sodium, chloral hydrate, ethchlorvynol, ethinamate, flurazepam hydrochloride, glutethimide, methotrimeprazine hydrochloride, methyprylon, midazolam hydrochloride, paraldehyde, pentobarbital, pentobarbital sodium, phenobarbital sodium, secobarbital sodium, talbutal, temazepam and triazolam; local anesthetics such as bupivacaine hydrochloride, chloroprocaine hydrochloride, etidocaine hydrochloride, lidocaine hydrochloride, mepivacaine hydrochloride, procaine hydrochloride and tetracaine hydrochloride; general anesthetics such as droperidol, etomidate, fentanyl citrate with droperidol, ketamine hydrochloride, methohexital sodium and thiopental sodium; and radioactive particles or ions such as strontium, iodide rhenium and yttrium.

In one embodiment, the term “drug” refers to a therapeutic compound. In one embodiment, the therapeutic compound is a peptide, a protein or a nucleic acid. In another embodiment, the therapeutic compound is organogenic, such as osteogenic, chondrogenic or angiogenic. In another embodiment, the therapeutic compound is an antibacterial, antiviral, antifungal or antiparasitic compound. In another embodiment, the therapeutic compound has cytotoxic or anti-cancer activity. In another embodiment, the therapeutic compound is an enzyme, a receptor, a channel protein, a hormone, a cytokine or a growth factor. In another embodiment, the therapeutic compound is immunostimulatory. In another embodiment, the therapeutic compound inhibits inflammatory or immune responses.

In one embodiment, the term “therapeutic” refers to a molecule, which when provided to a subject in need, provides a beneficial effect. In some cases, the molecule is therapeutic in that it functions to replace an absence or diminished presence of such a molecule in a subject. In one embodiment, the molecule is a nucleic acid coding for the expression of a protein is absent, such as in cases of an endogenous null mutant being compensated for by expression of the foreign protein. In other embodiments, the endogenous protein is mutated, and produces a non-functional protein, compensated for by the expression of a heterologous functional protein. In other embodiments, expression of a heterologous protein is additive to low endogenous levels, resulting in cumulative enhanced expression of a given protein. In other embodiments, the molecule stimulates a signaling cascade that provides for expression, or secretion, of a critical element for cellular or host functioning. In one embodiment, the therapeutic compound is a protein or polypeptide.

In one embodiment, the therapeutic protein may include cytokines, such as interferons or interleukins, or their receptors. Lack of expression of cytokines, or of the appropriate ones, has been implicated in susceptibility to diseases, and enhanced expression may lead to resistance to a number of infections. Expression patterns of cytokines may be altered to produce a beneficial effect, such as for example, a biasing of the immune response toward a Th1 type expression pattern, or a Th2 pattern in infection, or in autoimmune disease, wherein altered expression patterns may prove beneficial to the host.

Thus, in one embodiment, the nanoparticles of the present invention may control the timing and/or efficacy of therapeutic protein or drug delivery.

In another embodiment, the therapeutic protein may comprise an enzyme, such as one involved in glycogen storage or breakdown. In another embodiment, the therapeutic protein comprises a transporter, such as an ion transporter, for example CFTR, or a glucose transporter, or other transporters whose deficiency, or inappropriate expression, results in a variety of diseases.

In another embodiment, the therapeutic protein comprises a tumor suppressor, or pro-apoptotic compound, which alters progression of cancer-related events.

In another embodiment, the therapeutic compound used in the present invention may comprise an immunomodulating protein. In one embodiment, the immunomodulating protein comprises cytokines, chemokines, complement or components, such as interleukins 1 to 15, interferons alpha, beta or gamma, tumour necrosis factor, granulocyte-macrophage colony stimulating factor (GM-CSF), macrophage colony stimulating factor (M-CSF), granulocyte colony stimulating factor (G-CSF), chemokines such as neutrophil activating protein (NAP), macrophage chemoattractant and activating factor (MCAF), RANTES, macrophage inflammatory peptides MIP-1a and MIP-1b, or complement components.

In another embodiment, a therapeutic compound for use in this invention may comprise a growth factor, or tissue-promoting factor. In one embodiment, the therapeutic compound is a bone morphogenetic protein, or OP-1, OP-2, BMP-5, BMP-6, BMP-2, BMP-3, BMP-4, BMP-9, DPP, Vg-1, 60A, or Vgr-1. In another embodiment, the therapeutic compound facilitates nerve regeneration or repair, and may include NGF, or other growth factors.

In one embodiment, drug may also refer to a nucleic acid, or construct comprising a nucleic acid, whose expression ameliorates or abrogates symptoms of a disease or a disorder, or diminishes, suppresses or inhibits a disease, disorder or condition. In one embodiment, the nucleic acid or construct comprising the same, is used for gene therapy, for providing or replacing endogenous expression, or in another embodiment, suppressing endogenous expression.

In another embodiment, the therapeutic molecule may be natural or non-natural insulins, amylases, proteases, lipases, kinases, phosphatases, glycosyl transferases, trypsinogen, chymotrypsinogen, carboxypeptidases, hormones, ribonucleases, deoxyribonucleases, triacylglycerol lipase, phospholipase A2, elastases, amylases, blood clotting factors, UDP glucuronyl transferases, omithine transcarbamoylases, cytochrome p450 enzymes, adenosine deaminases, serum thymic factors, thymic humoral factors, thymopoietins, growth hormones, somatomedins, costimulatory factors, antibodies, colony stimulating factors, erythropoietin, epidermal growth factors, hepatic erythropoietic factors (hepatopoietin), liver-cell growth factors, interleukins, interferons, negative growth factors, fibroblast growth factors, transforming growth factors of the a family, transforming growth factors of the β family, gastrins, secretins, cholecystokinins, somatostatins, serotonins, substance P, transcription factors or combinations thereof.

In one embodiment, the nanoparticles of this invention may further comprise a ligand for a biological target, which in another embodiment, provides for directional specificity as to which cells or tissues are targeted by the nanoparticles of this invention. In one embodiment, the term “ligand for a biological target” refers to a molecule which enables the specific delivery of the nanoparticle of this invention to a particular site in vivo. In one embodiment, such a ligand may be referred to as an “anti-receptor”, which functions to direct the nanoparticle to, for example, virally infected cells, via anti-receptor binding to viral proteins expressed on infected cell surfaces. In this case, antireceptors to promote fusion with virally-infected cells, will recognize and bind to virally expressed surface proteins. For example, HIV-1 infected cells may express HIV-associated proteins, such as gp120, and therefore the presence of CD4 on the polymer or micelle surface promotes targeting to HIV infected cells, via CD4-gp120 interaction.

The anti-receptor proteins or polypeptide fragments thereof may be designed to enhance fusion with cells infected with members of the following viral families: Arenaviridae, Bunyaviridae, Coronaviridae, Filoviridae, Flaviviridae, Herpesviridae, Hepadnaviridae, Orthomyxoviridae, Paramyxoviridae, Poxviridae, Retroviridae, and Rhabdoviridae. Additional viral targeting agents may be derived from the following: African Swine Fever Virus, Borna Disease Virus, Hepatitis X, HIV-1, Human T Lymphocyte virus type-1 (HTLV-1), HTLV-2, 1 5 lentiviruses, Epstein-Barr Virus, papilloma viruses, herpes simplex viruses, hepatitis B and hepatitis C.

In another embodiment, targeting virally-infected cells may be accomplished through the additional expression of viral co-receptors on an exposed surface of the polymers/micelles of this invention, for enhanced fusion facilitation with infected cells. In one embodiment, the polymers/micelles of this invention comprise an HIV co-receptor such as CXCR4 or CCR5, for example.

Bacterial proteins expressed during intracellular infection are also potential targets contemplated for therapeutic intervention by polymers/micelles of this invention. The intracellular bacteria may include, amongst others: Shigella, Salmonella, Legionella, Streptococci, Mycobacteria, Francisella and Chlamydiae (See G. L. Mandell, “Introduction to Bacterial Disease” IN CECIL TEXTBOOK OF MEDICINE, (W.B. Saunders Co., 1996) 1556-7). These bacteria would be expected to express a bacteria-related protein on the surface of the infected cell to which the polymers/micelles of this invention would attach.

In another embodiment, the targeting moieties may include integrins or class II molecules of the MHC, which may be upregulated on infected cells such as professional antigen presenting cells.

Proteins of parasitic agents, which reside intracellularly, also are targets contemplated for targeting by the polymers/micelles of this invention. The intracellular parasites contemplated include for example, Protozoa. Protozoa, which infect cells, include: parasites of the genus Plasmodium (e.g., Plasmodium falciparum, P. Vivax, P. ovale and P. malariae), Trypanosoma, Toxoplasma, Leishmania, and Cryptosporidium.

Diseased and/or abnormal cells may be targeted using the polymers/micelles of this invention by the methods described above. The diseased or abnormal cells contemplated include: infected cells, neoplastic cells, pre-neoplastic cells, inflammatory foci, benign tumors or polyps, cafe au lait spots, leukoplakia, other skin moles, self-reactive cells, including T and/or NK cells, etc. Any cell to which specific delivery of an agent to modulate its activity is contemplated for the methods of this invention, and represents an embodiment thereof.

The nanoparticles of this invention may be targeted using an anti-receptor that will recognize and bind to its cognate receptor or ligand expressed on a diseased or abnormal cell, in another embodiment.

In one embodiment, the targeting agent specifically binds, or preferentially binds only diseased cells, for delivery of a therapeutic agent, or in another embodiment, a cytotoxic agent. In one embodiment, the targeting agent is an antibody, or fragment thereof. Examples of antibodies include those antibodies, which react with malignant prostatic epithelium but not with benign prostate tissue (e.g., ATCC No. HB-9119; ATCC HB-9120; and ATCC No. HB-1 1430) or react with malignant breast cancer cells but not with normal breast tissue (e.g., ATCC No. HB-8691; ATCC No. HB-10807; and 21HB-108011). Other antibodies or fragments thereof, which react with diseased tissue and not with normal tissue, would be apparent to the skilled artisan.

A wide variety of tumor-specific antibodies are known in the art, such as those described in U.S. Pat. Nos. 6,197,524, 6,191,255, 6,183,971, 6,162,606, 6,160,099, 6,143,873, 6,140,470, 6,139,869, 6,113,897, 6,106,833, 6,042,829, 6,042,828, 6,024,955, 6,020,153, 6,015,680, 5,990,297, 5,990,287, 5,972,628, 5,972,628, 5,959,084, 5,951,985, 5,939,532, 5,939,532, 5,939,277, 5,885,830, 5,874,255, 5,843,708, 5,837,845, 5,830,470, 5,792,616, 5,767,246, 5,747,048, 5,705,341, 5,690,935, 5,688,657, 5,688,505, 5,665,854, 5,656,444, 5,650,300, 5,643,740, 5,635,600, 5,589,573, 5,576,182, 5,552,526, 5,532,159, 5,525,337, 5,521,528, 5,519,120, 5,495,002, 5,474,755, 5,459,043, 5,427,917, 5,348,880, 5,344,919, 5,338,832, 5,298,393, 5,331,093, 5,244,801, and 5,169,774. See also The Monoclonal Antibody Index Volume 1: Cancer (3rd edition). Accordingly, the polymers, micelles and/or compositions of this invention may comprise tumor-specific antibodies which may recognize tumors derived from a wide variety of tissue types, including, but not limited to, breast, prostate, colon, lung, pharynx, thyroid, lymphoid, lymphatic, larynx, esophagus, oral mucosa, bladder, stomach, intestine, liver, pancreas, ovary, uterus, cervix, testes, dermis, bone, blood and brain.

In another embodiment, the polymers, micelles or compositions of this invention will incorporate an antibody which possesses tumoricidal activity. Antibodies that possess tumoricidal activity are also known in the art, including IMC-C225, EMD 72000, OvaRex Mab B43.13, anti-ganglioside G(D2) antibody ch14.18, CO17-1A, trastuzumab, rhuMAb VEGF, sc-321, AF349, BAF349, AF743, BAF743, MAB743, AB1875, Anti-Flt-4AB3127, FLT41-A, rituximab, 2C3, CAMPATH 1H, 2G7, Alpha IR-3, ABX-EGF, MDX447, anti-p75 IL-2R, anti-p64 IL-2R, and 2A11.

Epitopes to which tumor-specific antibodies bind are also well known in the art. For example, epitopes bound by the tumor-specific antibodies of the invention include, but are not limited to, those known in the art to be present on CA-125, gangliosides G(D2), G(M2) and G(D3), CD20, CD52, CD33, Ep-CAM, CEA, bombesin-like peptides, PSA, HER2/neu, epidermal growth factor receptor, erbB2, erbB3, erbB4, CD44v6, Ki-67, cancer-associated mucin, VEGF, VEGFRs (e.g., VEGFR3), estrogen receptors, Lewis-Y antigen, TGFβ1, IGF-1 receptor, EGFα, c-Kit receptor, transferrin receptor, IL-2R and CO17-1A. It is to be understood that antibodies to these, and other epitopes, may be designed by methods well known in the art, such as, for example, as described in Harlow and Lane (1988) Antibodies: A Laboratory Manual, Cold Spring Harbor Laboratory, New York (Harlow and Lane, 1988), or “Current Protocols in Immunology” (Coligan, 1991), and may be linked to or associated with the nanoparticles of this invention, and represents embodiments thereof.

In one embodiment, the targeting moiety is a peptide,. an antibody, an antibody fragment, a receptor, Protein A, Protein G, biotin, avidin, streptavidin, a metal ion chelate, an enzyme cofactor, a nucleic acid or a ligand.

In one embodiment, the targeting moiety may be an antibody, which specifically recognizes a molecule of interest, such as a protein or nucleic acid. In another embodiment, the antibody may specifically recognize a reporter molecule attached to a molecule of interest. In another embodiment, the targeting moiety may be an antibody fragment, Protein A, Protein G, biotin, avidin, streptavidin, a metal ion chelate, an enzyme cofactor, or a nucleic acid. In another embodiment, the targeting moiety may be a receptor, which binds to a cognate ligand of interest, or associated with a cell or molecule of interest, or in another embodiment, the targeting moiety may be a ligand which is used to attach to a cell via interaction with its cognate receptor.

In one embodiment, the term “immunoconjugate” refers to an antibody bound to a compound. In one embodiment, the conjugation of an antibody as described, with a nanoparticle of this invention represents the immunoconjugates comprising the invention. In another embodiment, the compound to which the antibody is bound, is conjugated to a nanoparticle of this invention, and is to be considered as part of this invention, or in another embodiment, the antibody, to which a compound is bound, is further conjugated to a nanoparticle of this invention.

In one embodiment, the term “a labeling agent” refers to a molecule which renders readily detectable that which is contacted with a labeling agent. In one embodiment, the labeling agent is a marker polypeptide. The marker polypeptide may comprise, for example, green fluorescent protein (GFP), DS-Red (red fluorescent protein), secreted alkaline phosphatase (SEAP), beta-galactosidase, luciferase, or any number of other reporter proteins known to one skilled in the art. In another embodiment, the labeling agent may be conjugated to another molecule which provides greater specificity for the target to be labeled. For example, and in one embodiment, the labeling agent is a fluorochrome conjugated to an antibody which specifically binds to a given target molecule, or in another embodiment, which specifically binds another antibody bound to a target molecule, such as will be readily appreciated by one skilled in the art.

In one embodiment, the term “toxin” refers to a molecule which results in toxic effects in cells and/or tissue exposed to the toxin. In one embodiment, the toxin results in cell death, or in another embodiment, cell damage. In one embodiment, the toxin is a natural product of cells, such as bacterial cells, wherein the toxin is used, in one embodiment, when specifically targeted to disease cells as a means of selective cell killing of diseased cells. In one embodiment, the toxin may comprise any known in the art, such as, for example that produced by cholera, tetanus, or any other appropriate species, as will be appreciated by one skilled in the art.

In another embodiment, this invention also comprises incorporation of any toxic substance for therapeutic purpose. In one embodiment, the nanoparticles of this invention may incorporate or be linked to an oligonucleotide encoding a suicide gene, which when in contact with diseased cells or tissue, is expressed within such cells. In one embodiment, the term “suicide gene” refers to a nucleic acid coding for a product, wherein the product causes cell death by itself or in the presence of other compounds. A representative example of a suicide gene is one, which codes for thymidine kinase of herpes simplex virus. Additional examples are thymidine kinase of varicella zoster virus and the bacterial gene cytosine deaminase, which can convert 5-fluorocytosine to the highly cytotoxic compound 5-fluorouracil.

Suicide genes may produce cytotoxicity by converting a prodrug to a product that is cytotoxic. In one embodiment, the term “prodrug” means any compound that can be converted to a toxic product for cells. Representative examples of such a prodrug is gancyclovir which is converted in vivo to a toxic compound by HSV-thymidine kinase. The gancyclovir derivative subsequently is toxic to cells. Other representative examples of prodrugs include acyclovir, FIAU [1-(2-deoxy-2-fluoro-β-D-arabinofuranosyl)-5-iodouracil], 6-methoxypurine arabinoside for VZV-TK, and 5-fluorocytosine for cytosine deaminase.

In another embodiment, the nanoparticles for use in this invention may comprise at least one molecule, which in another embodiment, is a protein, which is immunogenic.

In one embodiment, the term “immunogenic”, refers to an ability to elicit an immune response. Immune responses that are cell-mediated, or immune responses that are classically referred to as “humoral”, referring to antibody-mediated responses, or both, may be elicited by the nanoparticles comprising targeting moieties for use in the present invention.

Nanoparticles for use in this invention may, in one embodiment, be used for vaccine purposes, as a means of preventing infection.

In another embodiment, the nanoparticles conjugated to targeting moieties for use in this invention are utilized, to control an immunogenic protein or polypeptide eliciting a “Th1” response, in a disease where a so-called “Th2” type response has developed, when the development of a so-called “Th1” type response is beneficial to the subject. Introduction of the immunogenic protein or polypeptide results in a shift toward a Th1 type response.

As used herein, the term “Th2 type response” refers to a pattern of cytokine expression, elicited by T Helper cells as part of the adaptive immune response, which support the development of a robust antibody response. Typically Th2 type responses are beneficial in helminth infections in a subject, for example. Typically Th2 type responses are recognized by the production of interleukin-4 or interleukin 10, for example.

As used herein, the term “Th1 type response” refers to a pattern of cytokine expression, elicited by T Helper cells as part of the adaptive immune response, which support the development of robust cell-mediated immunity. Typically Th1 type responses are beneficial in intracellular infections in a subject, for example. Typically Th1 type responses are recognized by the production of interleukin-2 or interferon γ, for example.

In another embodiment, the reverse occurs, where a Th1 type response has developed, when Th2 type responses provide a more beneficial outcome to a subject, where nanoparticles of this invention linked to the immunogenic protein or polypeptide provides a shift to the more beneficial cytokine profile.

It is to be understood that any use of the magnetic nanoparticles of this invention comprising an immunogenic protein for purposes of control of immunizing a subject to prevent disease, and/or ameliorate disease, and/or alter disease progression are to be considered as part of this invention.

Examples of infectious virus to which stimulation of a protective immune response is desirable include: Retroviridae (e.g., human immunodeficiency viruses, such as HIV-1 (also referred to as HTLV-III, LAV or HTLV-III/LAV, or HIV-III; and other isolates, such as HIV-LP; Picornaviridae (e.g., polio viruses, hepatitis A virus; enteroviruses, human coxsackie viruses, rhinoviruses, echoviruses); Calciviridae (e.g., strains that cause gastroenteritis); Togaviridae (e.g., equine encephalitis viruses, rubella viruses); Flaviridae (e.g., dengue viruses, encephalitis viruses, yellow fever viruses); Coronaviridae (e.g., coronaviruses); Rhabdoviridae (e.g., vesicular stomatitis viruses, rabies viruses); Filoviridae (e.g., ebola viruses); Paramyxoviridae (e.g., parainfluenza viruses, mumps virus, measles virus, respiratory syncytial virus); Orthomyxoviridae (e.g. influenza viruses); Bungaviridae (e.g., Hantaan viruses, bunga viruses, phleboviruses and Nairo viruses); Arena viridae (hemorrhagic fever viruses); Reoviridae (erg., reoviruses, orbiviruses and rotaviruses); Bimaviridae; Hepadnaviridae (Hepatitis B virus); Parvoviridae (parvoviruses); Papovaviridae (papilloma viruses, polyoma viruses); Adenoviridae (most adenoviruses); Herpesviridae (herpes simplex virus (HSV) 1 and 2, varicella zoster virus, cytomegalovirus (CMV), herpes viruses); Poxviridae (variola viruses, vaccinia viruses, pox viruses); and Iridoviridae (e.g. African swine fever virus); and unclassified viruses (e.g., the etiological agents of Spongiform encephalopathies, the agent of delta hepatitis (thought to be a defective satellite of hepatitis B virus), the agents of non-A, non-B hepatitis (class 1 (internally transmitted); class 2 (parenterally transmitted; i.e., Hepatitis C); Norwalk and related viruses, and astroviruses).

Examples of infectious bacteria to which stimulation of a protective immune response is desirable include: Helicobacter pylori, Borellia burgdorferi, Legionella pneumophilia, Mycobacteria sps (e.g. M. tuberculosis, M. avium, M. intracellulare, M. kansaii, M. gordonae), Staphylococcus aureus, Neisseria gonorrhoeae, Neisseria meningitidis, Listeria monocytogenes, Streptococcus pyogenes (Group A Streptococcus), Streptococcus agalactiae (Group B Streptococcus), Streptococcus (viridans group), Streptococcus faecalis, Streptococcus bovis, Streptococcus (anaerobic sps.), Streptococcus pneumoniae, pathogenic Campylobacter sp., Enterococcus sp., Chlamidia sp., Haemophilus influenzae, Bacillus antracis, corynebacterium diphtheriae, corynebacterium sp., Erysipelothrix rhusiopathiae, Clostridium perfringers, Clostridium tetani, Enterobacter aerogenes, Klebsiella pneumoniae, Pasturella multocida, Bacteroides sp., Fusobacterium nucleatum, Streptobacillus moniliformis, Treponema pallidium, Treponema pertenue, Leptospira, Actinomyces israelli and Francisella tularensis.

Examples of infectious fungi to which stimulation of a protective immune response is desirable include: Cryptococcus neoformans, Histoplasma capsulatum, Coccidioides immitis, Blastomyces dermatitidis, Chlamydia trachomatis, Candida albicans. Other infectious organisms (i.e., protists) include: Plasmodium sp., Leishmania sp., Schistosoma sp. and Toxoplasma sp.

In another embodiment, the nanoparticles of this invention comprising an immunogenic protein further comprise additional immunomodulating proteins.

Examples of useful immunomodulating proteins include cytokines, chemokines, complement components, immune system accessory and adhesion molecules and their receptors of human or non-human animal specificity. Useful examples include GM-CSF, IL-2, IL-12, OX40, OX40L (gp34), lymphotactin, CD40, and CD40L. Further useful examples include interleukins for example interleukins 1 to 15, interferons alpha, beta or gamma, tumour necrosis factor, granulocyte-macrophage colony stimulating factor (GM-CSF), macrophage colony stimulating factor (M-CSF), granulocyte colony stimulating factor (G-CSF), chemokines such as neutrophil activating protein (NAP), macrophage chemoattractant and activating factor (MCAF), RANTES, macrophage inflammatory peptides MIP-1a and MIP-1b, complement components and their receptors, or an accessory molecule such as B7.1, B7.2, TRAP, ICAM-1, 2 or 3 and cytokine receptors. OX40 and OX40-ligand (gp34) are further useful examples of immunomodulatory proteins.

In another embodiment, the immunomodulatory proteins may be of human or non-human animal specificity, and may comprise extracellular domains and/or other fragments with comparable binding activity to the naturally occurring proteins. Immunomodulatory proteins may, in another embodiment, comprise mutated versions of the embodiments listed, or comprise fusion proteins with polypeptide sequences, such as immunoglobulin heavy chain constant domains. Multiple immunomodulatory proteins may be incorporated within a single construct, and as such, represents an additional embodiment of the invention.

It is to be understood that the nanoparticles for use in this invention may comprise multiple immunogenic proteins. In one embodiment, the immunogenic proteins or peptides are derived from the same or related species. Vaccine incorporation of multiple antigens has been shown to provide enhanced immunogenicity.

The nanoparticles of this invention comprising an immunogenic protein or peptide fragment may control the generation of immune responses of a variety of types that can be stimulated thus, including responses against the protein or peptide itself, other antigens that are now immunogenic via a “by-stander” effect, against host antigens, and others, and represent additional embodiments of the invention. It is envisioned that methods of the present invention can be used to prevent or treat bacterial, viral, parasitic or other disease states, including tumors, in a subject.

Combination vaccines have been shown to provide enhanced immunogenicity and protection, and, as such, in another embodiment, the immunogenic proteins or peptides are derived from different species.

Thus, it is to be understood that any probe or any targeting molecule may be used in conjunction with the magnetic nanoparticles of the instant invention for use in the methods of the present invention.

In one embodiment, the cell or tissue is infected, preneoplastic, neoplastic, hyperplastic, or a combination thereof.

In one embodiment, a neoplastic cell is a tumor cell, and may be present in tumors, or tissue or body fluids containing tumor cells. In one embodiment, neoplastic refers to abnormal, disorganized growth in a tissue or organ, usually forming a distinct mass. In one embodiment, such a growth is called a neoplasm, also known as a tumor. In another embodiment, neoplastic means cancerous. In one embodiment, neoplastic cells may be benign or malignant. In one embodiment, a pre-neoplastic cell is a cell that is morphologically identifiable as having a high malignant potential, but is not considered neoplastic.

In one embodiment, hyperplastic refers to a cell within an organ or tissue that shows an increase in size due to an increased number of cells. In one embodiment, hyperplasia may be due to increased demand, chronic inflammatory response, hormonal dysfunctions, neoplasia, or a combination thereof.

In another embodiment, the cell or tissue is exposed to a magnetic field with the aid of a magnetic resonance imaging system.

In one embodiment, the method results in the death of the cell, or cells in the tissue. In one embodiment, cell death is via cell lysis, following exposure to the heat, or in another embodiment, cell death is via apoptosis, stimulated as a result of the application of heat, via the methods described herein.

In another embodiment, this invention provides a method for remotely altering the structure of at least one protein in a plurality of proteins, the method comprising the steps of:
a. linking magnetic nanoparticles with said proteins, wherein at least one nanoparticle in said plurality dissipates greater heat upon exposure to a magnetic field, at a defined frequency, than another nanoparticle in said plurality; and
b. exposing said plurality of proteins to a magnetic field, at said defined frequency
   whereby said exposing results in an altering of the structure of said protein.

In one embodiment, the magnetic particles are linked to the protein via a covalent, or in another embodiment, non-covalent association, and in another embodiment, may comprise at least one targeting moiety, as described herein.

In one embodiment, the methods of this invention which alter protein structures may be used to convert a protein from an inactive form to an active form, or in another embodiment, from an active form to an inactive form. In one embodiment, this method may be used to alter protein structure in vivo. In another embodiment, the thermal generation of a nanoparticle of a particular material in a particular magnetic field alters the conformation of a protein to which it is linked, thereby inactivating a protein that is detrimental to a subject. In one embodiment, the heating of the protein alters protein conformation in a protein that is not functional or is malfunctioning and allows it to refold and function in a therapeutic or non-harmful manner, while in another embodiment, heat produced by a protein-linked magnetic nanoparticle alters a protein's conformation and inactivates said protein.

In another embodiment, this invention provides a method of drug delivery in a subject, comprising the steps of:
a. encapsulating a drug in structures comprising magnetic nanoparticles, wherein at least one nanoparticle in said nanoparticles dissipates greater heat upon exposure to a magnetic field, at a defined frequency, than another nanoparticle;
b. administering said structures to a subject;
c. exposing said structures to a magnetic field, at said defined frequency; and
   whereby said exposing results in an altering of said structures such that said drug is released in said subject.

In one embodiment, the structures are exposed to the magnetic field upon, or in another embodiment, just prior to, or in another embodiment, following transit of the structures to a desired region of a body of a subject. In one embodiment, the structures comprise different drugs, encapsulated in structures comprising different magnetic nanoparticles and temporal control of delivery of individual compounds may thus be affected by the methods of this invention.

It is to be understood that any of the methods, nanoparticles, or combination thereof as described herein, may be adapted or utilized for other corresponding methods, and are to be considered as part of this invention.

The particles may be bound to an array of biomolecules, including targeting moieties, specific for particular cells, tissues, etc. The cells/tissue may be diseased, in some embodiments, for example, they may be neoplastic or preneoplastic. In other embodiments, the cells may be infected.

In one embodiment, the nanoparticles are linked to nucleic acids, which may also undergo structural and/or functional changes, following exposure to heat, which may in turn, result in changes in gene expression, for example, as a result of denaturation of double stranded molecules, exposing nucleic acids to integration of other genetic material. Thus, in one embodiment, the methods as described herein may be utilized for gene transfer/introduction, at targeted sites, for example.

In some embodiments, following administration of the nanoparticles to a subject, or to a specific site, tissue, cell in a subject, an external magnetic field is applied, locally, or over an extended region of the subject, for example, and in some embodiments, via the use of the same instrument used for magnetic resonance imaging (MRI). The field applied, according to this aspect of the invention, will heat the particle and the targeted cell/tissue/organ, etc. for example, a tumor cell with which the particle is associated, and the heat is sufficient to result in cell death, by any means, including in some embodiments, selective induction of apoptosis.

In one embodiment, magnetic nanoparticles are contacted with cells, which in one embodiment are target cells, and which in one embodiment, are present in a tissue. As used herein, the term “contacting a target cell” refers to both direct and indirect exposure of the target cell to a nanoparticle of this invention. In one embodiment, contacting a cell may comprise direct injection of the cell through any means well known in the art, such as microinjection. It is also envisaged, in another embodiment, that supply to the cell is indirect, such as via provision in a culture medium that surrounds the cell.

Protocols for introducing the nanoparticles to cells and subject may comprise, for example: direct uptake techniques, injection, receptor-mediated uptake (for further detail see, for example, “Methods in Enzymology” Vol. 1-317, Academic Press, Current Protocols in Molecular Biology, Ausubel F. M. et al. (eds.) Greene Publishing Associates, (1989) and in Molecular Cloning: A Laboratory Manual, 2nd Edition, Sambrook et al. Cold Spring Harbor Laboratory Press, (1989), or other standard laboratory manuals), and others, as will be appreciated by one skilled in the art. It is to be understood that any direct means or indirect means of intracellular access of nanoparticles of the invention is contemplated herein, and represents an embodiment thereof.

In one embodiment, the cell which is targeted for uptake of nanoparticle of this invention may include any epithelial cell, muscle cell, nerve cell, lung cell, kidney cell, liver cell, astrocyte, glial cell, prostate cell, professional antigen presenting cell, lymphocyte, M cell, or any other cell in the body, where the nanoparticles of this invention may be useful.

In one embodiment, the nanoparticles of this invention may be administered in any effective, convenient manner including, for instance, administration by intravascular (i.v.), intramuscular (i.m.), intranasal (i.n.), subcutaneous (s.c.), oral, rectal, intravaginal delivery, or by any means in which the polymers or micelles or compositions of this invention can be delivered to tissue (e.g., needle or catheter). Alternatively, topical administration may be desired for insertion into epithelial cells. Another method of administration is via aspiration or aerosol formulation.

For administration to mammals, and particularly humans, it is expected that a physician will determine the actual dosage and duration of treatment, which will be most suitable for an individual and can vary with the age, weight and response of the particular individual.

According to this aspect of the invention, the disease for which the subject is thus treated may comprise, but is not limited to: muscular dystrophy, cancer, cardiovascular disease, hypertension, infection, renal disease, neurodegenerative disease, such as Alzheimer's disease, Parkinson's disease, Huntington's chorea, Creuztfeld-Jacob disease, autoimmune disease, such as lupus, rheumatoid arthritis, endocarditis, Graves' disease or ALD, respiratory disease such as asthma or cystic fibrosis, bone disease, such as osteoporosis, joint disease, liver disease, disease of the skin, such as psoriasis or eczema, ophthalmic disease, otolaryngeal disease, other neurological disease such as Turret syndrome, schizophrenia, depression, autism, or stoke, or metabolic disease such as a glycogen storage disease or diabetes. It is to be understood that any disease whereby expression of a particular protein, provision of a therapeutic protein, provision of a drug, inhibition of expression of a particular protein, etc., which can be accomplished via the use of the nanoparticles of this invention is sought, is to be considered as part of this invention.

In some embodiments, particles are varied such that they can be heated independently of each other. In some embodiments, these particles are conjugated to different targeting moieties, which in turn enable the respective particles to bind to different sites, for specific temporal regulation of delivery of various compounds, or heat to a particular site.

In some embodiments, the structures comprising different drugs bound to nanoparticles, which differ in terms of the frequency, are selectively heated, according to the methods of this invention. In one embodiment, such structures are administered to a subject, then the subject, or parts of the subject are subjected to a magnetic field, where at the defined frequency, the structure comprising the appropriate nanoparticle release the specific drugs contained within the structure, selectively, as a function of the frequency of the external magnetic field applied.

In one embodiment, heat released from nanoparticles may be used to control protein expression. Thus, according to this aspect and in one embodiment, nanoparticles of the present invention may be used to activate or inhibit thermosensitive promoters, which in one embodiment are known in the art and may comprise cI578 (λP_{R}), cIts847, hsp70 and others.

It will be readily apparent to one skilled in the art the numerous applications of selective nanoparticle heating, and such applications are to be considered as part of this invention.

### EXAMPLES

### Example 1

### Power Loss As A Function of Frequency

By exploiting the size and material dependence of nanoparticle heating, a method for independently heating different nanoparticle types can be achieved, since power loss (P) is a function of the material property, magnetic field frequency and particle size.

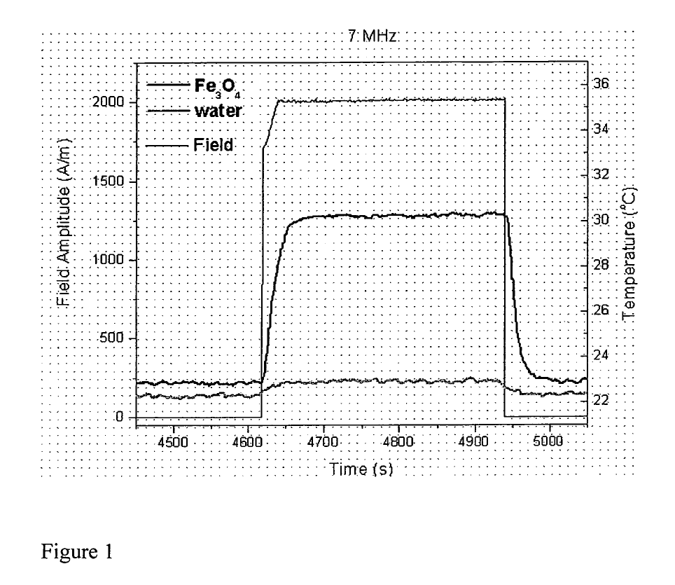

FIG. 1 demonstrates the calculated frequency dependence for Fe₃O₄ particles. The specific absorbance rate (SAR) is calculated according to EQ. 5:

$$SAR ? c \frac{ⅆ T}{ⅆ t} \qquad ( EQ . 5 )$$

Where c=the specific heat capacity of the solution and dT/dt=the temperature increase per unit time.

SAR is also approximated by the following equation:
SAR ? kfⁿ H^{m} (EQ. 6)

Where n=1.0-1.5 and m≈2.0.

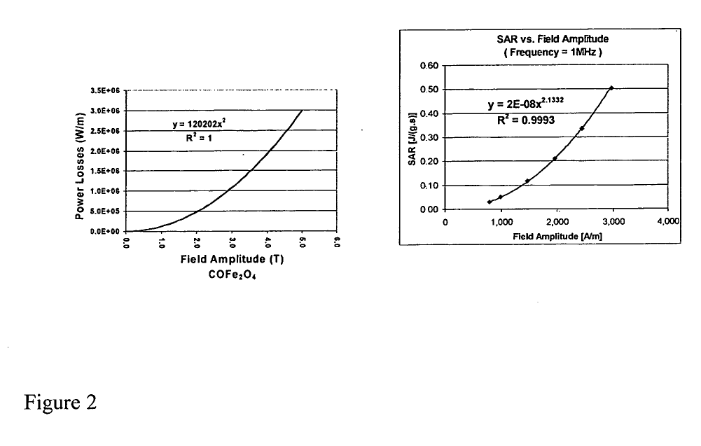

FIG. 2 demonstrates the calculated field amplitude dependence for CoFe₂O₄.

Thus, field amplitude, which is dependent upon the specific frequency, varies as a function of SAR or power loss.

### Example 2

### Varied Frequency And Field Amplitude Applied To Nanoparticles of Different Materials

In one embodiment, three types of nanoparticles of different materials can be shown to have heating curves, which differ, as a function of frequency, shown in FIG. 3A. The frequency dependence is seen to vary depending upon the material of the particle used.

Nanoparticle size also plays a role (FIG. 3B), with optimal nanoparticles size for given material represented by the peak for each material. A representative SEM for some of the particles are shown in FIG. 3C.

Even greater control may be achieved, via tuning of the 3 variables (FIG. 3D). Application of a 90mT field at frequency f₁ heats CoFe₂O₄ nanoparticles, and Fe₃O₄ and Fe₂O₃ particles are not heated to the same degree. Application of a lower field (10mT) at a frequency of f₂ preferentially heats Fe₃O₄ particles, with CoFe₂O₄ nanoparticles, and Fe₂O₃ particles not heated to the same degree, etc. The manipulation of these variables enables independent heating.

### Example 3

### Nanoparticle Heating Applications

Independent heating of nanoparticles may be applied to a multitude of applications, including biomolecular applications. The nanoparticles may serve as an antenna, whereby inductive heating of the nanoparticles heats a biomolecule attached to the nanoparticles.

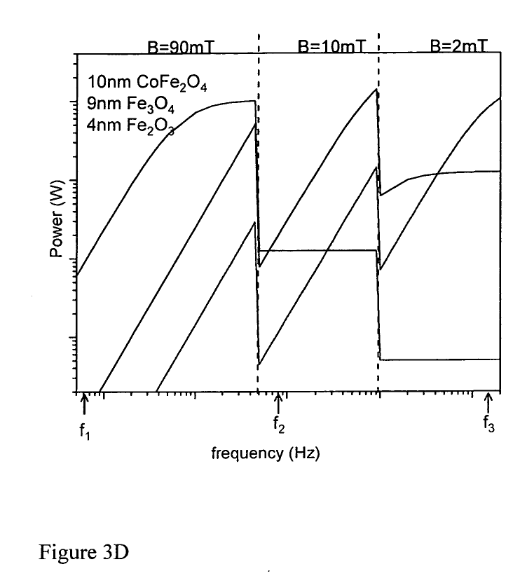

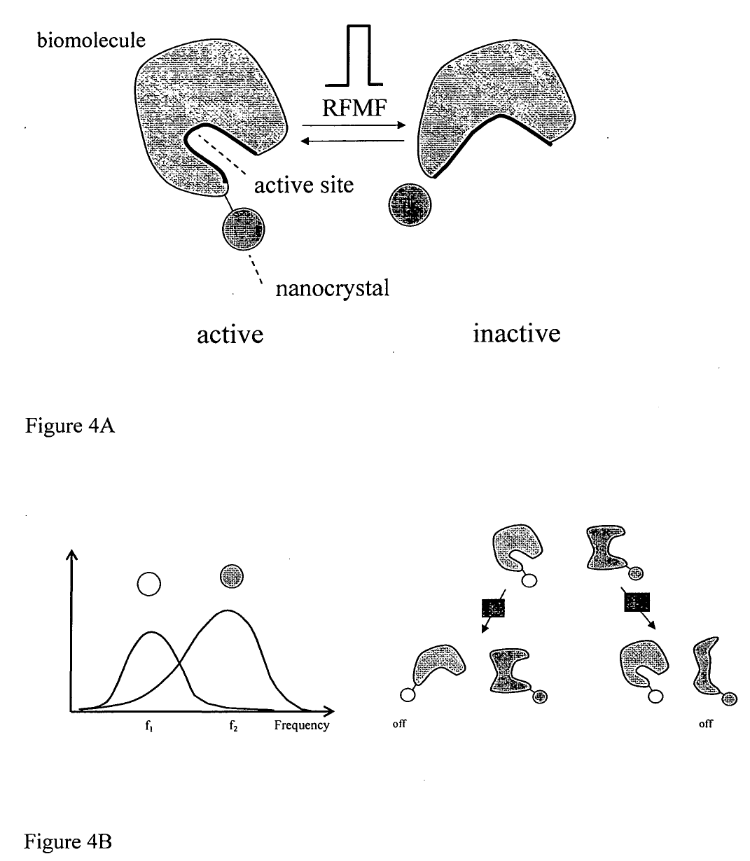

In some embodiments, such specifically applied heat induces a conformational change in the protein, which may convert a biologically inactive form to an active form, or vice versa (FIG. 4A). Another application is the ability to provide a localized heat force. The methods provide the ability to address multiple biomolecules independently, using size dependence, materials dependence, or a combination thereof (FIG. 4B).

Some applications of the technique include the ability to non-invasively burn tumors for cancer therapy, by application of an alternating magnetic field. Each nanoparticle type can be functionalized to incorporate targeting moieties, for example, antibodies recognizing specific antigens on tumor cells, for specific tumor targeting. The technique provides the versatility of targeted tumor therapy, with the ability to treat multiple tumor sites independently.

Another application of the technique is in drug delivery. In one embodiment, the nanoparticles are functionalized to be attached to a vesicle or capsule containing a drug. Heating the particles, enables heating the polymer capsule or other vesicle like structure, which then releases the contained drugs. Again, the versatility of the method provides for delivery of multiple drugs independently by changing the field frequency and amplitude.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of selective heating of at least one magnetic nanoparticle in a composition comprising a plurality of magnetic nanoparticles, said method comprising the step of exposing said composition to a magnetic field, whereby said at least one nanoparticle emits greater heat upon exposure to said magnetic field, at a defined frequency, than another nanoparticle in said plurality.

2. The method of claim 1, wherein said plurality comprises magnetic nanoparticles which differ in terms of their composition, radius, or combination thereof.

3. The method of claim I, wherein said nanoparticles comprise CoFe₂O₄, Fe₃O₄, Fe₂O₃, or a combination thereof.

4. A method for inducing hyperthermia in a cell or tissue comprising the steps of:
a. contacting said cell or tissue with a plurality of magnetic nanoparticles, wherein at least one nanoparticle in said plurality emits greater heat upon exposure to a magnetic field, at a defined frequency, than another nanoparticle in said plurality; and
b. exposing said cell or tissue to a magnetic field, at said defined frequency.

5. The method of claim 4 wherein said nanoparticles comprise CoFe₂O₄, Fe₃O₄, Fe₂O₃, or a combination thereof.

6. The method of claim 4, wherein said plurality comprises magnetic nanoparticles which differ in terms of their composition, radius, or combination thereof.

7. The method of claim 4, wherein said nanoparticles comprise at least one targeting moiety.

8. The method of claim 7 wherein said targeting moiety is an antibody, ligand, receptor, cross-linking agent, nucleic acid, or combination thereof.

9. The method of claim 4 wherein said cell or tissue is infected, preneoplastic, neoplastic or a combination thereof.

10. The method of claim 4, wherein said exposing to said magnetic field is accomplished with the aid of a magnetic resonance imaging system.

11. The method of claim 4, wherein said method results in the death of said cell or one or more cells in said tissue.

12. A method for remotely altering the structure of at least one protein in a plurality of proteins, the method comprising the steps of:
a. linking magnetic nanoparticles with said proteins, wherein at least one nanoparticle in said plurality emits greater heat upon exposure to a magnetic field, at a defined frequency, than another nanoparticle in said plurality; and
b. exposing said plurality of proteins to a magnetic field, at said defined frequency.
whereby said exposing results in an altering of the structure of said protein.

13. The method of claim 12, wherein said linking is covalent.

14. The method of claim 12, wherein said nanoparticles comprise CoFe₂O₄, Fe₃O₄, Fe₂O₃, or a combination thereof.

15. The method of claim 12, wherein said nanoparticles differ in terms of their composition, radius, or combination thereof.

16. The method of claim 12, wherein said nanoparticles comprise at least one targeting moiety.

17. The method of claim 16 wherein said targeting moiety is an antibody, ligand, receptor, cross-linking agent, or combination thereof.

18. A method for drug delivery in a subject, comprising the steps of:
a. encapsulating a drug in structures comprising magnetic nanoparticles, wherein at least one nanoparticle among said nanoparticles emits greater heat upon exposure to a magnetic field, at a defined frequency, than another nanoparticle;
b. exposing said structures to a magnetic field, at said defined frequency; and
c. administering said structures to a subject;
whereby said exposing results in an altering of said structures such that said drug is released in said subject.

19. The method of claim 18, wherein said exposing is accomplished upon transit of said structures to a desired region of a body of a subject.

20. The method of claim 18, wherein said subject is administered structures which comprise different drugs.

21. The method of claim 18, wherein said structures are linked covalently to said nanoparticles.

22. The method of claim 18, wherein said nanoparticles comprise CoFe₂O₄ Fe₃O₄, Fe₂O₃, or a combination thereof.

23. The method of claim 18, wherein said nanoparticles differ in terms of their composition, radius, or combination thereof.

24. The method of claim 18, wherein said nanoparticles comprise at least one targeting moiety.

25. The method of claim 24 wherein said targeting moiety is an antibody, ligand, receptor, cross-linking agent, or combination thereof.

26. A composition comprising a plurality of magnetic nanoparticles, wherein at least one nanoparticle of said plurality of nanoparticles emits greater heat upon exposure to a magnetic field, at a defined frequency, than another nanoparticle in said plurality.

27. The composition of claim 26, wherein said plurality comprises magnetic nanoparticles which differ in terms of their composition, radius, or combination thereof.

28. The composition of claim 26, wherein said nanoparticles comprise CoFe₂O₄, Fe₃O₄ Fe₂O₃, or a combination thereof.

29. The composition of claim 26, wherein said nanoparticles comprise at least one targeting moiety.

30. The composition of claim 26, wherein said targeting moiety is an antibody, ligand, receptor, cross-linking agent, or combination thereof.
